(19) United States
(12) Patent Application Publication
(10) Pub. No.: US 2014/0205853 A1
(43) Pub. Date: Jul. 24, 2014

(54) TRANSPARENT CONDUCTIVE COATING FILM, TRANSPARENT CONDUCTIVE INK, AND TOUCH PANEL USING TRANSPARENT CONDUCTIVE COATING FILM OR TRANSPARENT CONDUCTIVE INK

(71) Applicant: FUJIFILM CORPORATION, Tokyo (JP)

(72) Inventors: Takeshi FUNAKUBO, Ashigarakami-gun (JP); Kenichi Yamamoto, Ashigarakami-gun (JP); Nori Miyagishima, Ashigarakami-gun (JP)

(73) Assignee: FUJIFILM CORPORATION, Tokyo (JP)

(21) Appl. No.: 14/225,021

(22) Filed: Mar. 25, 2014

Related U.S. Application Data
(63) Continuation of application No. PCT/JP2012/073263, filed on Sep. 12, 2012.

(30) Foreign Application Priority Data
Sep. 29, 2011 (JP) 2011-215055
Jul. 27, 2012 (JP) 2012-166533

(51) Int. Cl. H01B 1/02

(52) U.S. Cl. CPC H01B 1/02
USPC 428/605; 420/501

(57) ABSTRACT

A transparent conductive coating film comprising at least a metal nanowire, wherein the transparent conductive coating film has a ratio of a bent wire in the metal nanowire of 10% or less, a surface resistivity of 150 Ω/□ or less, and a haze value of 1.0% or less.

### CROSS-REFERENCE TO RELATED APPLICATIONS

This application is a continuation application and claims the priority benefit under 35 U.S.C. §120 of PCT Application No. PCT/JP2012/073263 filed on Sep. 12, 2012 which application designates the U.S., and also claims the priority benefit under 35 U.S.C. §119 of Japanese Patent Application Nos. 2011-215055 filed on Sep. 29, 2011 and 2012-166533 filed on Jul. 27, 2012, which applications are all hereby incorporated by reference in their entireties.

### BACKGROUND OF THE INVENTION

1. Field of the Invention

The present invention relates to a transparent conductive coating film, a transparent conductive ink, and a touch panel using the transparent conductive coating film or the transparent conductive ink and relates in particular to a transparent conductive coating film and a transparent conductive ink comprising at least a metal nanowire.

2. Description of the Related Art

Various studies on a transparent conductive coating film using a metal nanowire have been tried in the past.

It is known that the metal nanowire is a metal of which quality of material is liable to bend; further has a banana-shaped loose curvature as a whole because the metal nanowire has a thickness of as small as some nanometers to some hundred nanometers in the shape and a high aspect ratio (length/thickness of a fiber) and stress is liable to be concentrated on the metal nanowire; and furthermore has a local bend.

It has been shown in the paragraph [0014] of Japanese Patent Application Laid-Open No. 2009-70660, for example, that a curved or bent wire having a low stiffness exists other than a branched nanowire.

Moreover, the metal nanowire has a high specific surface area and therefore is liable to cause aggregation, and it is difficult to disperse the metal nanowire without causing aggregation. Strong dispersion such as mill or ultrasonic dispersion under the presence of a dispersant can be carried out in the case of a spherical nanoparticle, but a problem of the case of the metal nanowire is that strong stress is applied to the wire and the wire is bent when the dispersion in which strong energy is applied to the wire is carried out.

So it is disclosed in Japanese Patent Application Laid-Open No. 2011-84844, which is with regard to a carbon nanofiber, that a carbon nanofiber having a small ratio of a branched or bent nanofiber can be obtained by carrying out pressure applying treatment and carrying out kneading in an elastomer for preventing a bend of the carbon nanofiber.

### SUMMARY OF INVENTION

However, the carbon nanofiber having a small ratio of a branched or bent nanofiber can be obtained in Japanese Patent Application Laid-Open No. 2011-84844, but since the metal nanowire has a low strength, a lot of bend occurs with stress being applied to the wire by desalting in preparing the metal nanowire dispersion liquid, shear during the time of a dispersion treatment step, or pressure applying treatment after forming a coating film. As described here, the bend or curve occurs in the metal nanowire having a low stiffness due to the quality of material and the shape characteristics. It has come to be understood that it is difficult to obtain a transparent conductive film in which both of the surface resistivity and the haze value are achieved as the number of the bent wires is larger. Furthermore the tendency is remarkable as the wire diameter is smaller.

Since a metal nanowire that is an opaque fine particle is present in a transparent conductive coating film using the metal nanowire, a problem thereof is that it is difficult to increase the transmittance or to reduce the haze value while maintaining a high conductivity. It can be expected to reduce the haze value by making the wire diameter small, but the ratio of the bent wire is increased with the decrease in the wire diameter and therefore it is difficult to achieve both of the high conductivity and the low haze.

The present invention has been made to solve the newly found problem as described above, intends to provide a transparent conductive coating film and a transparent conductive ink capable of making the transmittance higher and reducing the haze value more than in the past while maintaining a high conductivity, and intends to provide a touch panel using the transparent conductive coating film or the transparent conductive ink.

The present invention is a transparent conductive coating film comprising at least a metal nanowire wherein the transparent conductive coating film has a ratio of a bent wire in the metal nanowire of 10% or less, a surface resistivity of 150Ω/□ or less, and a haze value of 1.0% or less for the purpose of achieving the object.

Moreover, the present invention is a transparent conductive ink comprising at least a metal nanowire wherein the transparent conductive ink has a ratio of a bent wire in the metal nanowire of 10% or less and a conductivity of 1 mS/cm or less for the purpose of achieving the object.

As described above, the transmittance can be made high and the haze value can be reduced while maintaining a high conductivity by making the ratio of the bent wire in the metal nanowire 10% or less.

In addition, the “bent wire” in the present invention does not mean a naturally curved wire but means a particle in which one part or a plurality of parts in one wire are deformed by a different amount of curvature from other parts of the wire. Specifically, when a circumscribed circle is assumed at the part where the wire is deformed by a different amount of curvature from the other parts, a wire that bends so that a radius of the circumscribed circle (radius of curvature) is smaller than 150 nm is defined as a bent wire. In the case where the wire bends with the curvature continuously changing, the radius of curvature at the part where the radius of curvature is the smallest is defined as the radius of curvature of the wire.

In addition, the clear reason why the transparent conductive film having a low resistivity and a low haze is obtained by the metal nanowire having a small ratio of the bent wire has not been understood, but it is thought that the reason is because the arrangement of the metal atoms is suddenly changed at the bent part and therefore scattering behavior of phonons or electrons is greatly changed. It is hard to think that a wire in the wire growth grows bending in consideration of the growth mechanism of a metal nanowire, and it is thought that the bent wire is generated by the local stress being applied to the wire in the middle of the growth or in the process of producing the transparent conductive film after forming the wire. The bend of the wire can occur at any stage in a step after the wire growing step but often occurs in the desalting or the dispersion step of the wire particularly. It is thought that the reason is because the stress is applied to the wire in respective steps, particularly in the desalting and the dispersion steps.

It is preferable that the transparent conductive coating film of the present invention has a ratio of the bent wire of 2.5% or less.

A transparent conductive coating film having a transmittance of 92% or more can be provided in the transparent conductive coating film of the present invention. Moreover, a transparent conductive coating film having a haze value of 0.6% or less can be provided in the transparent conductive coating film of the present invention.

It is preferable that the metal nanowire has a number average aspect ratio of 20 or more in the transparent conductive coating film of the present invention. And it is preferable that the metal nanowire has a number average major axis diameter of 1 μm or more in the transparent conductive coating film of the present invention. Moreover, the metal nanowire has a number average minor axis diameter of preferably 50 nm or less, more preferably 30 nm or less, further more preferably 20 nm or less in the transparent conductive coating film of the present invention.

Objectives of using a thin wire includes the realization of a high transmittance and a low haze, but when the thin wire is handled in the same manner as a usual thick wire, a bend occurs, the transmittance or the haze is deteriorated, and the merit of using a thin wire disappears. Therefore, the present invention is particularly effective in the case where the metal nanowire is a thin metal nanowire as described above.

In the case where the ratio of the bent wire is 2.5% or less, the high conductivity, the high transmittance, and the low haze at a level that cannot be realized with a thick wire can be realized, in the case where the ratio of the bent wire is more than 2.5% and 10% or less, superiority to the thick wire in terms of the transmittance and the haze can be maintained, but when the bent wire is contained more than 10%, the property becomes equal to or less than the property in the case of the thick wire without a bend, therefore the ratio of the bent wire of 10% or less is necessary, and 2.5% or less is preferable.

It is preferable that the transparent conductive ink has a Br content per metal nanowire solid content in the ink of 5000 ppm or less in the transparent conductive ink of the present invention.

And in the present invention, it is preferable that a purification step in preparing the metal nanowire dispersion liquid is an ultrafiltration system and a liquid feeding pump used in ultrafiltration is any one of a tube pump, a mohno pump, a diaphragm pump, and a rotary pump.

Moreover, according to the transparent conductive coating film or the transparent conductive ink of the present invention, the transmittance can be made high and the haze value can be reduced while maintaining a high conductivity and therefore the transparent conductive coating film or the transparent conductive ink of the present invention can suitably be used for a touch panel.

According to the transparent conductive coating film or the transparent conductive ink of the present invention, a transparent conductive coating film and a transparent conductive ink capable of making the transmittance higher and reducing the haze value more than in the past while maintaining a high conductivity can be provided.

### BRIEF DESCRIPTION OF THE DRAWINGS

FIG. 1 is an explanatory drawing showing a “bent wire”.

FIG. 2 is a diagram showing Examples.

### DETAILED DESCRIPTION OF THE PREFERRED EMBODIMENTS

### Conductive Ink, Conductive Film, and Method for Manufacturing Conductive Ink or Conductive Film

A transparent conductive ink and a transparent conductive coating film of the present invention are a transparent conductive ink and a transparent conductive coating film comprising at least a metal nanowire wherein the ratio of number of a bent wire in the metal nanowire is 10% or less. The ratio of number of the bent wire is preferably 2.5% or less.

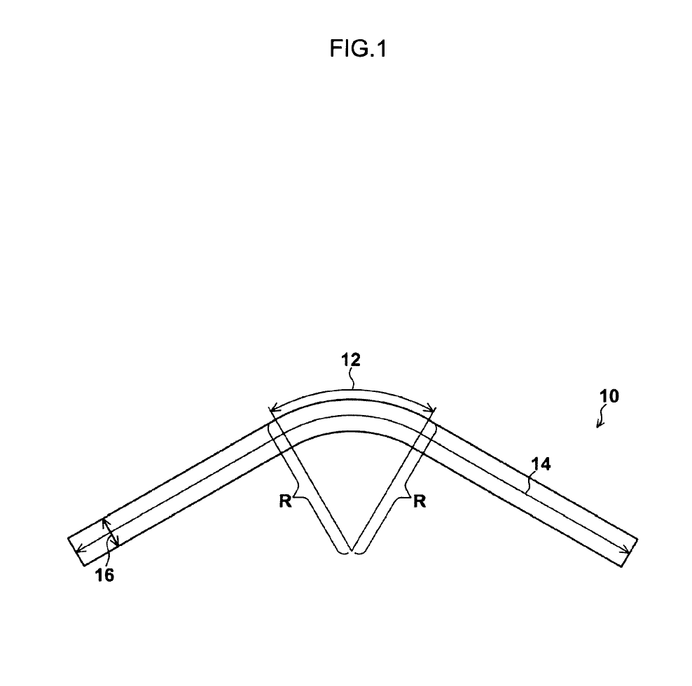

In addition, the “bent wire 10” means a particle having a small radius of curvature of circumscription 12 of the wire as shown in FIG. 1. Specifically, the feature is that a bent wire having a radius of curvature R of the circumscription smaller than 150 nm is as small as 10% or less. In the case where the wire bends with the curvature continuously changing, the radius of curvature at the part where the radius of curvature is the smallest is defined as the radius of curvature of the wire.

The bent wire can be measured by ordinary means such as observation by a transmission electron microscope (TEM) for the ink or observation by a scanning electron microscopy (SEM) for the coating film, but the bent wire is liable to be entangled to aggregate in a process before the coating, it often occurs that the bent wire is present in an aggregated state, and therefore it is impossible to determine the correct ratio by observing, in a TEM or SEM photograph, only the particles in a region where the particles are dispersed. Even if bent particles are hardly recognized when some TEM and SEM photographs are observed, bent particles exist at a high ratio in the rare aggregate of particles. Accordingly, it is necessary to observe a lot of particles of all the particles including the particles in the region where the particles are aggregated. Therefore, it is possible to determine the correct ratio of number of the bent particle by observing the presence or absence of bend for 10000 or more particles and counting the ratio of the bent particles/all the particles.

The transparent conductive ink and the transparent conductive coating film of the present invention are manufactured by the manufacturing method described below.

<<Metal Nanowire Dispersion Liquid>>

The metal nanowire dispersion liquid comprises a metal nanowire, a solvent, a dispersant, and further another component as necessary, and is also referred to as a conductive ink.

—Metal Nanowire—

The metal nanowire in the present invention designates a particle having a minor axis diameter (diameter) of 50 nm or less and an average major axis diameter (length) of 1 μm or more.

In the case where the metal nanowire is a thin metal nanowire, a bend is liable to occur, and the present invention is particularly effective.

The average minor axis diameter of the metal nanowire is preferably 50 nm or less, more preferably 30 nm or less, further more preferably 20 nm or less. In addition, it is preferable to make the minor axis diameter 5 nm or more because an antioxidative property can be imparted. Moreover, it is preferable to make the average minor axis diameter 50 nm or less because the scattering attributable to the metal nanowire can be suppressed and the transparency can be made high.

The average major axis diameter of the metal nanowire is preferably 1 μm or more, more preferably 5 μm or more. In addition, it is preferable to make the major axis diameter of the metal nanowire 1 mm or less because it is possible to make the aggregate hard to occur in the manufacturing process. Moreover, it is preferable to make the average major axis diameter 1 μm or more because wires easily form a network and the conductivity can be easily made high.

Here, the average minor axis diameter and the average major axis diameter of the metal nanowire can be determined, for example, by using a transmission electron microscope (TEM) or an optical microscope and observing a TEM image or an optical microscope image, and the minor axis diameter and the major axis diameter of the metal nanowire in the present invention are determined from the average value of the values obtained by observing 300 metal nanowires by the transmission electron microscope (TEM).

In the present invention, the metal nanowire having a minor axis diameter of 50 nm or less and a major axis diameter of 1 μm or more is contained by a metal content of 50 mass % or more in the whole metal particles, preferably 60 mass % or more, more preferably 75 mass % or more.

It is preferable to make the ratio of the metal nanowire having a minor axis diameter of 50 nm or less and a major axis diameter of 1 μm or more (hereinafter, sometimes referred to as “appropriate wire ratio”) 50 mass % or more because the ratio of the metal contributing to the conductivity is increased, concentration of voltage to a particular metal particle can be suppressed, and therefore durability is easily improved. Moreover, the metal nanowire is preferable because the metal nanowire can make the degree of transparency high more easily than a metal particle that exhibits strong plasmon absorption such as a spherical metal particle.

Here, in the case where the metal nanowire is a silver nanowire, for example, the appropriate wire ratio can be determined by filtrating silver nanowire aqueous dispersion liquid, separating the silver nanowire and the other particles, and measuring the amount of silver (Ag) remained on the filter paper and the amount of Ag passing through the filter paper by using an ICP emission analyzing apparatus. The metal nanowire remained on the filter paper is confirmed to be a metal nanowire having a minor axis diameter of 50 nm or less and a major axis diameter of 1 μm or more by observing the metal nanowire remained on the filter paper by a transmission electron microscope (TEM), observing the minor axis diameters of 300 metal nanowires, and checking the distribution. In addition, it is preferable to use a filter paper having a diameter 5 times or more larger than the longest axis and equal to or less than ½ of the shortest length of the major axis of the wire by measuring, by a TEM image, the longest axis of the particles other the metal nanowire having a minor axis diameter of 50 nm or less and a major axis diameter of 1 μm or more.

The coefficient of variation of the minor axis diameter (diameter) of the metal nanowire of the present invention is preferably 40% or less, more preferably 35% or less, further more preferably 30% or less.

When the coefficient of variation exceeds 40%, it sometimes occurs that the durability is deteriorated probably because the voltage concentrates on the wire having a short minor axis diameter.

The coefficient of variation of the minor axis diameter of the metal nanowire can be determined, for example, by measuring the minor axis diameters of 300 nanowires from a transmission electron microscope (TEM) image and calculating the standard deviation and the average value (coefficient of variation of minor axis diameter=standard deviation of minor axis diameter/average value of minor axis diameter).

The metal nanowire of the present invention can take an arbitrary shape such as a cylindrical shape, a rectangular parallelepiped shape, a columnar shape of which cross-sectional shape is a polygon, but a cylindrical shape or a cross-sectional shape that is a polygon as a cross section with the corners rounded is preferable in applications in which high transparency is required.

The cross-sectional shape of the metal nanowire can be checked by coating a base material with a metal nanowire aqueous dispersion liquid, drying the metal nanowire aqueous dispersion liquid, and observing the cross section of the film by a transmission electron microscope (TEM).

A metal of the metal nanowire is not particularly limited, may be any metal, may be used in combination of two or more metals besides one metal, and can be used as alloy. Among the metal nanowires, a metal nanowire formed from a metal or a metal compound is preferable, and a metal nanowire formed from a metal is more preferable.

Examples of the metal include copper, silver, gold, platinum, palladium, nickel, tin, cobalt, rhodium, iridium, iron, ruthenium, osmium, manganese, molybdenum, tungsten, niobium, tantalum, titanium, bismuth, antimony, and lead, or alloys thereof. Among these metals, copper, silver, gold, platinum, palladium, nickel, tin, cobalt, rhodium, and iridium or alloys thereof are preferable, palladium, copper, silver, gold, platinum, and tin or alloys thereof are more preferable, and silver or an alloy comprising silver is particularly preferable.

The content of the metal nanowire in the metal nanowire dispersion liquid is preferably 0.1 mass % to 99 mass %, more preferably 0.3 mass % to 95 mass %.

<<Method for Manufacturing Metal Nanowire>>

A method for manufacturing the metal nanowire is not particularly limited and can be appropriately selected depending on the intended purpose, and examples of the method for manufacturing the metal nanowire include (1) a polyol method (see U.S. Patent Application Laid-Open No. 2005/0056118 Description and U.S. Patent Application Laid-Open No. 2007/0074316 Description) and (2) a method for manufacturing a metal nanowire comprising: at least a step of adding a solution of a metal complex to a water medium containing a halogen compound and a reducing agent and heating the resultant mixture; and preferably a desalting treatment step. Among these methods, the method for manufacturing a metal nanowire of the above-described (2) is particularly preferable.

<<Method for Manufacturing Metal Nanowire of the Above-Described (2)>>

The method for manufacturing a metal nanowire of the above-described (2) comprises: at least a step of adding a solution of a metal complex to a water medium containing a halogen compound and a reducing agent and heating the resultant mixture; and preferably a desalting treatment step, and further comprises another step as necessary.

—Metal Complex—

The metal complex is not particularly limited and can be appropriately selected depending on the intended purpose, but a silver complex is particularly preferable. Examples of a ligand of the silver complex include NO₃⁻, CN⁻, SCN⁻, SO₃²⁻, thiourea, and ammonia. These ligands can be found in the description of “The Theory of the Photographic Process 4th Edition” Macmillan Publishing, written by T. H. James. Among the silver complexes, silver nitrate and a silver ammonia complex are particularly preferable.

It is preferable that the addition of the metal complex is carried out after the addition of a dispersant and a halogen compound. The addition of the metal complex after the addition of a dispersant and a halogen compound has the effect of increasing the ratio of the metal nanowire having an appropriate minor axis diameter or an appropriate major axis diameter in the present invention probably because a wire core can be formed with high probability.

A hydrophilic solvent is preferable as the solvent, and examples of the hydrophilic solvent include water, alcohols such as methanol, ethanol, propanol, isopropanol, and butanol; ethers such as dioxane and tetrahydrofuran; ketones such as acetone, and cyclic ethers such as tetrahydrofuran and dioxane.

The heating temperature is preferably 150° C. or less, more preferably 20° C. or more and 130° C. or less, further more preferably 30° C. or more and 100° C. or less, particularly preferably 40° C. or more and 90° C. or less. The temperature may be changed in the middle of the forming process of the particle if necessary, and the temperature change in mid-course sometimes has effect in controlling the formation of the core, suppressing the regeneration of the core, and improving the monodispersity by the facilitation of selective growth.

It is preferable to make the heating temperature 150° C. or less because it becomes possible to make the corners of the cross section of the nanowire round and to easily make the transmittance high in the evaluation of the coating film. Moreover, it is preferable to make the heating temperature 20° C. or more because the length of the wire can be adjusted in an appropriate range and it is possible to make the dispersion stability favorable.

—Reducing Agent—

It is preferable that the heating is carried out by adding a reducing agent. The reducing agent is not particularly limited and can be appropriately selected from reducing agents usually used, and examples of the reducing agent include metal borohydrides such as sodium borohydride and potassium borohydride; aluminum hydride salts such as lithium aluminum hydride, potassium aluminum hydride, cesium aluminum hydride, beryllium aluminum hydride, magnesium aluminum hydride, and calcium aluminum hydride; sodium sulfite, hydrazine compounds, dextrins, hydroquinones, hydroxylamines, citric acid or a salt thereof, succinic acid or a salt thereof, and ascorbic acid or a salt thereof; alkanolamines such as diethylaminoethanol, ethanolamine, propanolamine, triethanolamine, and dimethylaminopropanol; aliphatic amines such as propylamine, butylamine, dipropyleneamine, ethylenediamine, and triethylenepentamine; heterocyclic amines such as piperidine, pyrrolidine, N-methylpirrolidine, and morpholine; aromatic amines such as aniline, N-methylaniline, toluidine, anisidine, and phenetidine; aralkyl amines such as benzylamine, xylenediamine, and N-methylbenzylamine; alcohols such as methanol, ethanol, and 2-propanol; ethylene glycol, glutathione, organic acids (such as citric acid, malic acid, and tartaric acid), reducing sugars (such as glucose, galactose, mannose, fructose, sucrose, maltose, raffinose, and stachyose), and sugar alcohols (such as sorbitol). Among these reducing agents, reducing sugars and sugar alcohols as derivatives of reducing sugars are particularly preferable. In addition, a reducing agent sometimes also functions as a dispersant depending on the kind of a reducing agent, and such a reducing agent is preferably used similarly.

The timing of the addition of the reducing agent may be before or after the addition of a dispersant and may be before or after the addition of a halogen compound.

—Halogen Compound—

It is preferable that the manufacturing of the metal nanowire of the present invention is carried out by adding a halogen compound.

The halogen compound is not particularly limited as long as the halogen compound is a compound containing bromine, chlorine, and iodine and can be appropriately selected depending on the intended purpose, and alkali halides such as, for example, sodium bromide, sodium chloride, sodium iodide, potassium bromide, potassium chloride, potassium iodide, and a compound that can also be used as a dispersant described below are preferable. The timing of the addition of the halogen compound may be before or after the addition of the dispersant and may be before or after the addition of the reducing agent.

In addition, a halogen compound that also functions as a dispersant can exist depending on the kind of a halogen compound, and such a halogen compound is preferably used similarly.

A halogenated metal fine particle may be used as a substitute for the halogen compound, and the halogen compound and the halogenated metal fine particle may be used together.

A certain halogen compound or a certain halogenated metal fine particle that also functions as a dispersant exists and is preferably used. Examples of the halogen compound having a function as a dispersant include hexadecyltrimethylammonium bromide (HTAB) containing an amino group and a bromide ion and hexadecyltrimethylammonium chloride (HTAC) containing an amino group and a chloride ion.

—Dispersant—

It is preferable that the manufacturing of the metal nanowire is carried out by adding a dispersant. In addition, the shape of the obtained metal nanowire can be changed depending on the kind of the dispersant to be used. With regard to the stage of adding the dispersant, the dispersant may be added before the preparation of the particle, may be added under the presence of a dispersing polymer, or may be added after the preparation of the particle for the purpose of controlling the dispersion state. In the case where the addition of the dispersant is separated by two or more stages, it is necessary to change the amount of addition according to the required length of the wire. The reason is considered to be attributable to the length of the wire depending on controlling the amount of the metal particle to become a core.

The dispersant is not particularly limited and can be appropriately selected depending on the intended purpose, and examples of the dispersant include ionic surfactants such as quaternary alkylammonium salts, amino group-containing compounds, thiol group-containing compounds, sulfide group-containing compounds, amino acids or the derivatives thereof, peptide compounds, polysaccharides, natural polymers derived from polysaccharides, and synthetic polymers or polymers derived therefrom such as a gel. Among these compounds, the quaternary alkylammonium salts are particularly preferable because washing at the time of immersion is easily carried out.

Examples of the quaternary alkylammonium salt include hexadecyltrimethylammonium bromide (HTAB), hexadecyltrimethylammonium chloride, stearyltrimethylammonium bromide (STAB), stearyltrimethylammonium chloride, tetradecyltrimethylammonium bromide, tetradecyltrimethylammonium chloride, dilauryldimethylammonium bromide, and dilauryldimethylammonium chloride. These quaternary alkylammonium salts may be used singly or in combinations of two or more. Among these quaternary alkylammonium salts, hexadecyltrimethylammonium bromide (HTAB) is particularly preferable.

Examples of the polymers include polymers having protective colloid properties such as gelatin, polyvinyl alcohols, methyl cellulose, hydroxypropyl cellulose, polyalkylene amines, partial alkyl esters of polyacrylic acid; polyvinylpyrrolidones (PVP), and polyvinylpyrrolidone copolymers.

The structure that is usable as the dispersant can be found, for example, in the description of “Ganryo no Jiten (Pigment Dictionary)” (edited by Seishiro Ito, published from Asakura Shoten Co., Ltd., 2000).

—Dispersion Solvent—

Water is mainly used as a dispersion solvent in the metal nanowire dispersion liquid, and an organic solvent that is mixed with water can be used with water in a ratio of 80 volume % or less.

As the organic solvent, for example, an alcohol based compound having a boiling point of 50° C. to 250° C., more preferably 55° C. to 200° C. is favorably used. By using such an alcohol based compound together with water, application in the coating step can be improved, and drying load can be reduced.

The alcohol based compound is not particularly limited and can be appropriately selected depending on the intended purpose, and examples of the alcohol based compound include methanol, ethanol, ethylene glycol, diethylene glycol, triethylene glycol, polyethylene glycol 200, polyethylene glycol 300, glycerin, propylene glycol, dipropylene glycol, 1,3-propanediol, 1,2-butanediol, 1,4-butanediol, 1,5-pentanediol, 1-ethoxy-2-propanol, ethanolamine, diethanolamine, 2-(2-aminoethoxy)ethanol, and 2-dimethylamino isopropanol. These alcohol based compounds may be used singly or in combinations of two or more.

—Desalting Treatment—

The desalting treatment can be carried out by a method such as an ultrafiltration, a dialysis, a gel filtration, a decantation, or a centrifugal separation method after forming the metal nanowire.

During the desalting treatment and the dispersion treatment with a dispersion solvent described below, stress is liable to be applied to the metal wire and the metal wire is liable to be bent.

It is hard to think that a wire in the wire growth grows bending in consideration of the growth mechanism of a metal nanowire, and it is thought that the bent wire is generated by the local stress being applied to the wire in the middle of the growth or in the process of producing the transparent conductive film after forming the wire.

The bend of the wire can occur at any stage in a step after the wire growing step but often occurs in the desalting or the dispersion step of the wire in particular. It is thought that the reason is because the stress is applied to the wire in respective steps, in particular, in the desalting and the dispersion steps.

Accordingly, the transparent conductive ink and the transparent conductive coating film comprising at least a metal nanowire of the present invention have a ratio of the bent wire in the metal nanowire of 10% or less, preferably a ratio of the bent wire of 2.5% or less, but it is necessary that the stress not be applied to the wire in the desalting treatment and the dispersion treatment to reduce the bent wires.

The amount of an inorganic ion such as an alkali metal ion, an alkaline earth metal ion, and an ion of a halogenated compound in the metal nanowire dispersion liquid is determined by the desalting treatment and the dispersion treatment, but when the desalting is insufficient, the inorganic ion remained in the dispersion liquid sometimes becomes a factor of deterioration of durability when a conductive member is produced, and therefore it is preferable that the inorganic ion is not contained if possible.

The electric conductivity of the metal nanowire dispersion liquid is determined by the desalting treatment or the dispersion treatment, but when the desalting is insufficient, the salt remained in the dispersion liquid sometimes becomes a factor of deterioration of durability when a conductive member is produced, and therefore the metal nanowire dispersion liquid has an electric conductivity of preferably 1 mS/cm or less, more preferably 0.3 mS/cm or less.

The metal nanowire dispersion liquid has a viscosity of preferably 0.5 mPa·s to 100 mPa·s at 20° C., more preferably 1 mPa·s to 50 mPa·s.

—Additives—

The metal nanowire dispersion liquid can contain a binder or various additives such as, for example, a surfactant, a polymerizable compound, an antioxidizing agent, an antisulfurizing agent, a corrosion inhibitor, a viscosity modifier, and an antiseptic as necessary.

The binder is not particularly limited and can be appropriately selected depending on the intended purpose, and examples of the binder include sol-gel cured products, gelatin, gelatin derivatives, casein, agar, starch, polyvinyl alcohols, polyacrylic acid copolymers, carboxymethyl cellulose, hydroxyethyl cellulose, polyvinylpyrrolidone, and dextran. These compounds may be used singly or in combinations of two or more.

The content of the binder in the metal nanowire dispersion liquid is not particularly limited and can be appropriately selected depending on the intended purpose, but the content of the binder is preferably 0.01 parts by mass to 10 parts by mass based on 1 part by mass of silver, more preferably 0.1 parts by mass to 5 parts by mass.

The corrosion inhibitor is not particularly limited and can be appropriately selected depending on the intended purpose, and azoles are favorable. Examples of the azoles include benzotriazole, tolyltriazole, mercaptobenzothiazole, mercaptobenzotriazole, mercaptobenzotetrazole, (2-benzothiazolyl thio) acetic acid, 3-(2-benzothiazolyl thio)propionic acid, and at least one selected from the group consisting of alkali metal salts, ammonium salts, and amine salts thereof. The metal nanowire dispersion liquid of the present invention can exhibit an excellent rust prevention effect by containing the corrosion inhibitor.

—Base Material—

A base material which is coated with the metal nanowire dispersion liquid is not particularly limited and can be appropriately selected depending on the intended purpose, and examples of the base material include a transparent glass substrate such as white sheet glass, blue sheet glass, and silica-coated blue sheet glass; a sheet, film or substrate made of a synthetic resin such as polycarbonate resins, polyethersulfone resins, polyester resins, acrylic resins, polyvinyl chloride resins, aromatic polyamide resins, polyamideimide resins, and polyimide resins; a metal substrate such as an aluminum sheet, a copper sheet, a nickel sheet, a stainless steel sheet; and besides, a ceramic sheet, a semiconductor substrate having a photoelectric conversion element. Pretreatment such as chemical treatment such as silane coupling treatment; and plasma treatment, ion plating, sputtering, a vapor phase reaction method, and vacuum deposition can be applied to these substrates as desired.

<<Metal Nanowire-Containing Film Producing Step>>

A metal nanowire-containing film producing step is a step of producing a metal nanowire-containing film containing a metal nanowire and a dispersant.

In the case of producing the metal nanowire-containing film, it is preferable that the production of the metal nanowire-containing film is carried out by coating a base material with a metal nanowire dispersion liquid containing a metal nanowire and a dispersant and drying the metal nanowire dispersion liquid.

Examples of the method for coating with the metal nanowire dispersion liquid include a spin coating method, a casting method, a roll coating method, a flow coating method, a printing method, a dip coating method, a casting film forming method, a bar coating method, a gravure printing method, and a die coating method.

In addition, it is preferable that a purification step in preparing the metal nanowire dispersion liquid is an ultrafiltration system and a liquid feeding pump used in ultrafiltration is any one of a tube pump, a mohno pump, a diaphragm pump, and a rotary pump.

An ultrafiltration apparatus includes at least a tank in which a metal nanowire coarse dispersion liquid to be an object of the purification is stored, a filter separating the metal nanowire coarse dispersion liquid in the tank into filtrate and concentrated liquid, and a pump for feeding the metal nanowire coarse dispersion liquid in the tank. Moreover, the ultrafiltration apparatus may include a heat exchanger for controlling the temperature of the liquid circulating in the apparatus. Furthermore, the ultrafiltration apparatus may include pressure gauges on the upstream side of the filter and between the filter and the heat exchanger separately in order to grasp the filtration condition more correctly.

As the quality of material of the filter, the material to be used is not particularly limited, and a hollow fiber membrane of a polymer member selected from cellulose based polymers, polyethersulfone based polymers, PTFE, and so on can be used, or a porous ceramic membrane can be used.

The pore size of the filter can be freely selected without limitation in particular as long as salts can be washed, the size that can also remove a low molecular dispersant used at the time of synthesizing the metal nanowire is more preferable, the size that can remove a surplus polymer dispersant in the polymer dispersant added in a mixing step is more preferable, and the size that can remove a by-product particle that is generated in the metal nanowire synthesizing step and is other than a wire-shaped particle (hereinafter referred to as noise particle) is further more preferable. Specifically, the pore size is preferably 40 Å or more, more preferably 100 Å or more, further more preferably 500 Å or more. Moreover, when the pore size is too large, it sometimes occurs that the pore is clogged with the metal nanowires and the metal nanowires aggregate, and therefore the pore size is preferably 5 μm or less, more preferably 1 μm or less, further more preferably 0.25 μm or less.

The purification step by ultrafiltration will be described. A metal nanowire coarse dispersion liquid to be an object of the purification is put into the tank and is circulated in the apparatus by operating the liquid feeding pump. Since a part of the solvent is discharged out of the filter as filtrate when the metal nanowire coarse dispersion liquid passes through the filter, the metal nanowire coarse dispersion liquid is more concentrated than before passing through the filter and is returned to the tank. The concentration of the metal nanowire coarse dispersion liquid is carried out by repeating the above-described step while an unpurified metal nanowire coarse dispersion liquid is appropriately supplied in the tank additionally.

After the completion of the concentration of the metal nanowire coarse dispersion liquid, a washing solvent is put into the tank, and washing of the concentrated metal nanowire coarse dispersion liquid is carried out. The washing of the metal nanowire coarse dispersion liquid and the substitution of the solvents can be carried out in a state where the change of the metal nanowire concentration is suppressed by repeating the discharge of the filtrate from the filter while appropriately supplying the washing solvent.

In the purification step of the present embodiment, the filtration speed can be adjusted by applying pressure to the filter part as necessary. The average of pressures at the parts over and under the filter is defined as the filtration pressure. When the filtration pressure is too high, it sometimes occurs that the solid deposited on the filter is compressed and is not redispersed even though the solid is removed from the filter surface by the back washing described below, and therefore the filtration pressure is preferably 0.5 MPa or less, more preferably 0.4 MPa or less, further more preferably 0.2 MPa or less. Moreover when the filtration pressure is too low, the filtration flow rate becomes low and the process time becomes long, and therefore the filtration pressure is preferably 0.01 MPa or more, more preferably 0.02 MPa or more, further more preferably 0.03 MPa or more.

In the purification step of the present embodiment, it is desirable that the back washing is carried out at regular intervals while the concentration and the washing are carried out in order to suppress the lowering of the filtration efficiency due to the deposition of the solid on the filter. The back washing is an operation that pushes back the filtrate from the filter surface in contact with the filtrate to the filter surface in contact with the dispersion liquid. Pressure may be applied to the filtrate in the filtrate flow path in a direction opposite to the filtrate discharge direction by using a gas such as, for example, air in order to push back the filtrate. The level of the pressure pushing back the filtrate is defined, in the case where a gas is used for pushing back the filtrate, as the difference of the filtration pressure and the gas pressure for pushing back the filtrate, and the difference of the filtration pressure and the gas pressure for pushing back the filtrate is referred to as back washing pressure. The back washing pressure is not particularly limited as long as the solid deposited on the filter can be removed from the filter surface, but when the pressure is too low, the solid deposited on the filter cannot be removed, and therefore the back washing pressure is preferably 0.1 MPa or more, more preferably 0.2 MPa or more, further more preferably 0.3 MPa or more. Moreover, when the pressure is too high, it sometimes occurs that the gas used for pushing back the filtrate is mixed in the dispersion liquid and disturbs the flow in the circulation flow path, and therefore it is preferable the back washing pressure is 10 MPa or less, more preferably 5 MPa or less, further more preferably 3 MPa or less. Moreover, the interval at which the back washing is carried out is not particularly limited as long as the solid deposited on the filter surface can be removed, but when the interval is too long, the solid cannot be removed from the filter surface, and therefore an interval of 30 minutes or less is preferable, an interval of 15 minutes or less is more preferable, and an interval of 10 minute or less is further more preferable. Furthermore, since the filtration is not carried out while the back washing is carried out, when the back washing interval is too short, the process time becomes long and therefore the interval is preferably 15 seconds or more, more preferably 1 minute or more, further more preferably 3 minutes or more.

In the purification step, the purification of the dispersion liquid can be carried out without excessively increasing the metal concentration by adding a washing liquid after concentrating the metal nanowire coarse dispersion liquid. The washing liquid can be used without limitation in particular as long as the metal nanowire does not aggregate. Particularly, the washing liquid in which a salt intended to be removed, a low molecular dispersant used at the time of synthesizing the metal nanowire, and a surplus polymer dispersant in the polymer dispersant added in the mixing step are dissolved is preferable.

The thickness of the transparent conductive coating film produced in the manner as described above is preferably 0.02 μm to 1 μm, more preferably 0.03 μm to 0.3 μm.

It is preferable that the conductive film of the present invention has a surface resistivity of 150Ω/□ or less.

Here, the surface resistivity can be measured by, for example, a four-terminal method.

It is preferable that the transparent conductive coating film of the present invention has a light transmittance of 92% or more. The transparent conductive coating film of the present invention has preferably a haze value of 1.0% or less, more preferably 0.6% or less.

Here, the transmittance can be measured by, for example, an ultraviolet and visible spectrophotometer (UV2400-PC manufactured by Shimadzu Corporation), and the haze value can be measured by, for example, a Haze-Guard plus (manufactured by Gardner).

The transparent conductive coating film of the present invention can greatly improve the transparency and the conductivity and therefore is widely applied to, for example, a touch panel, an electrode for a display, an electromagnetic wave shield, an electrode for an organic or inorganic EL display, electronic paper, an electrode for a flexible display, an integrated type solar cell, a display element, other various devices, and so on. Among these applied products, a touch panel, a display element, and an integrated type solar cell are preferable, and a touch panel is particularly preferable.

(Touch Panel)

In the case where the transparent conductive coating film of the present invention is used as a transparent conductor of a touch panel, a touch panel excellent in visibility due to improvement in transmittance and excellent in responsiveness to input of text or the like or to screen operation by at least one of a bare hand, a gloved hand, or an indication tool due to improvement in conductivity can be manufactured.

The touch panel includes a widely known touch panel, and the transparent conductive coating film of the present invention can be applied to a product known as a so-called touch sensor and a touch pad.

The touch panel can be appropriately selected depending on the intended purpose without limitation in particular as long as the touch panel has the transparent conductive coating film, and examples of the touch panel include a surface type capacitance system touch panel, a projection type capacitance system touch panel, and a resistance film system touch panel.

### EXAMPLES

### Example 1

### Silver Nanowire Dispersion Liquid 1

[Addition Liquid B]

In 100 ml of ethylene glycol, 2.6 mg of silver nitrate was dissolved.

[Addition Liquid C]

In 1000 ml of ethylene glycol, 17 g of silver nitrate was dissolved.

[Addition Liquid D]

In 1000 ml of ethylene glycol, 56 g of PVP was dissolved.

A silver nanowire dispersion liquid 1 was synthesized by the following method referring to the method written in Adv. Mater. 2002 14 833-837.

To 1000 ml of an ethylene glycol solution heated at 170° C., the whole amount of the addition liquid B was added in 7 seconds under stirring. After 2 hours, the stirring was set to 100 rpm, and the whole amount of the addition liquid C and the whole amount of the addition liquid D were added simultaneously in 100 minutes to obtain a silver nanowire dispersion liquid 1.

### Silver Nanowire Dispersion Liquid 2

The following addition liquids A, G, and H were prepared in advance.

[Addition Liquid A]

In 150 mL of pure water, 0.90 g of powdered silver nitrate was dissolved. Thereafter, 1N aqueous ammonia was added to the resultant solution until the solution became transparent. And pure water was added so that the whole amount of the solution became 300 mL.

[Addition Liquid G]

The addition liquid G was prepared by dissolving 1.0 g of powdered glucose in 280 mL of pure water.

[Addition Liquid H]

The addition liquid H was prepared by dissolving 0.5 g of powdered HTAB (hexadecyl-trimethylammonium bromide) in 27.5 mL of pure water.

Next, a silver nanowire dispersion liquid 2 was prepared in the following manner.

In a three-necked flask, 410 mL of pure water was placed, and 82.5 mL of the addition liquid H and 206 mL of the addition liquid G were added with a funnel under stirring at 20° C. (first stage). To the liquid, 206 mL of the addition liquid A was added at a flow rate of 2.0 mL/min and a revolution number of stirring of 800 rpm (second stage). After 10 minutes, 82.5 mL of the addition liquid H was added (third stage). Thereafter, the temperature was raised at 3° C./min to an internal temperature of 85° C. And thereafter, the revolution number of stirring was set to 1000 rpm, the liquid mixture was heated for 5 hours.

### Silver Nanowire Dispersion Liquid 3

A silver nanowire dispersion liquid 3 was obtained in the same manner as in the preparation of the silver nanowire dispersion liquid 2 except that the addition liquid A to be added was added by making the concentration of silver nitrate 2 times.

### Silver Nanowire Dispersion Liquid 4

A silver nanowire dispersion liquid 4 was obtained in the same manner as in the preparation of the silver nanowire dispersion liquid 2 except that the revolution number of stirring after raising the temperature to 85° C. was dropped to 100 rpm instead of 1000 rpm in the preparation of the silver nanowire dispersion liquid 3.

### Silver Nanowire Dispersion Liquid 5

A silver nanowire dispersion liquid 5 was obtained in the same manner as in the preparation of the silver nanowire dispersion liquid 2 except that the heating time at an internal temperature of 85° C. and a revolution number of stirring of 1000 rpm was changed from 5 hours to 2 hours in the preparation of the silver nanowire dispersion liquid 2.

[Average Minor Axis Diameter (Average Diameter) and Average Major Axis Diameter of Silver Nanowire]

Using a transmission electron microscope (TEM; JEM-2000FX manufactured by JEOL Ltd.), 300 silver nanowires were observed to determine the average minor axis diameter and the average major axis diameter of the silver nanowire.

<<Production of Sample Liquid 1>>

Centrifugal separation was carried out taking 100 ml of the silver nanowire dispersion liquid 1 at 60000 rpm for 30 minutes by a centrifugal separator CR21G manufactured by Hitachi, 80 ml of supernatant was discarded, and thereafter ultrasonic dispersion was carried out for 5 minutes using an ultrasonic disperser UH-300 manufactured by STM Corporation to disperse the silver nanowire. Then 80 ml of ethanol was added to the dispersion liquid, and the operation of centrifugal separation—removal of supernatant—addition of solvent was repeated 5 times, thereafter centrifugal separation was carried out, the supernatant was removed as much as possible, and ultrasonic dispersion was carried out. To the dispersion liquid, 100 ml of propylene glycol monomethyl ether instead of ethanol was added, and ultrasonic dispersion was carried out for 10 minutes to obtain sample liquid 1.

<<Production of Sample Liquid 2>>

Sample liquid 2 was produced in the same manner as in the production of sample liquid 1 except that the silver nanowire dispersion liquid 1 was changed to the silver nanowire dispersion liquid 2.

<<Production of Sample Liquid 3>>

Sample liquid 3 was produced in the same manner as in the production of sample liquid 1 except that the silver nanowire dispersion liquid 1 was changed to the silver nanowire dispersion liquid 3.

<<Production of Sample liquid 4>>

To 100 ml of the silver nanowire dispersion liquid 3, 40 ml of 1% toluene liquid of Solsperse 2400SC (manufactured by Zeneca K.K.) was added, and the resultant mixture was stirred. Further, 200 ml of ethanol was added to the mixture, and the resultant mixture was stirred for 10 minutes. The mixture was left standing for 16 hours after stirring, and only the toluene layer in which the silver nanowire was extracted was recovered. To the toluene solution, 100 ml of ethanol was further added, and centrifugal separation was carried out at 6000 rpm for 30 minutes. After the supernatant was discarded as much as possible, 100 ml of propylene glycol monomethyl ether acetate was added, and ultrasonic dispersion was carried out for 10 minutes to obtain sample liquid 4.

<<Production of Sample Liquid 5>>

Taking 1000 ml of the silver nanowire dispersion liquid 2, then 500 ml of a 0.02 mol/l aqueous solution of polyvinylpyrrolidone (K-30 manufactured by Wako Pure Chemical Industries, Ltd.) was added to the silver nanowire dispersion liquid 2, and the same volume of ethanol was added to the resultant mixture while the resultant mixture was stirred well. Ultrafiltration was carried out using a precision filtration film UNA620 (manufactured by Asahi Kasei Corporation) having a bore size of 0.2 μm and a MDGR15 type gear pump manufactured by Iwaki Co., Ltd. as a liquid feeding pump. Washing of adding 800 mL of ethanol solution to the concentrated liquid at the time when the filtrate from the module reached 800 ml was continuously carried out 2 times, and thereafter washing of adding 800 mL of propylene glycol monomethyl ether when the concentrated liquid reached 200 ml was carried out 4 times. Thereafter, concentration was carried out until the concentrated liquid reached 100 ml to obtain sample liquid 5.

<<Production of Sample Liquid 6>>

Sample liquid 6 was obtained in the same manner as in the production of sample liquid 5 except that the concentration was carried out until the concentrated liquid reached 100 ml without carrying out the washing with propylene glycol monomethyl ether after carrying out the washing of adding 800 ml of ethanol solution 2 times.

<<Production of Sample Liquid 7>>

The silver nanowire dispersion liquid 2 itself without carrying out the washing with ethanol, the washing with propylene glycol monomethyl ether, and the concentration was used as sample liquid 7.

<<Production of Sample Liquid 8>>

A sample liquid 8 was obtained in the same manner as in the production of sample liquid 5 except that the liquid feeding pump at the time of the ultrafiltration was changed to a canned pump manufactured by Teikoku Electric MFG. Co., Ltd. (F60-3211N2BL).

<<Production of Sample Liquid 9>>

Sample liquid 9 was obtained in the same manner as in the production of sample liquid 5 except that the liquid feeding pump at the time of the ultrafiltration was changed to a triple plunger pump manufactured by Nikkiso Co., Ltd.

<<Production of Sample Liquid 10>>

Sample liquid 10 was obtained in the same manner as in the production of sample liquid 5 except that the liquid feeding pump at the time of the ultrafiltration was changed to a WM720 type tubing pump manufactured by Iwaki Co., Ltd.

<<Production of Sample Liquid 11>>

Sample liquid 11 was obtained in the same manner as in the production of sample liquid 10 except that the number of times of carrying out the washing of adding 800 mL of propylene glycol monomethyl ether was changed to 2 instead of 4.

<<Production of Sample Liquid 12>>

Sample liquid 12 was produced in the same manner as in the production of sample liquid 10 except that the silver nanowire dispersion liquid 2 was changed to the silver nanowire dispersion liquid 5.

<<Production of Sample Liquid 13>>

Sample liquid 13 was produced in the same manner as in the production of sample liquid 10 except that the silver nanowire dispersion liquid 2 was changed to the silver nanowire dispersion liquid 3.

<<Production of Sample Liquid 14>>

Sample liquid 14 was produced in the same manner as in the production of sample liquid 10 except that the silver nanowire dispersion liquid 2 was changed to the silver nanowire dispersion liquid 4.

<<Production of Sample Liquid 15>>

Sample liquid 15 was obtained in the same manner as in the production of sample liquid 13 except that the liquid feeding pump at the time of the ultrafiltration was changed to a mohno pump (NL20) manufactured by Heishin Ltd.

<<Production of Sample Liquid 16>>

Sample liquid 16 was obtained in the same manner as in the production of sample liquid 13 except that the liquid feeding pump at the time of the ultrafiltration was changed to a diaphragm pump (TPL 1MC-014-6T6-CW-4-S) manufactured by Tacmina Corporation.

<<Production of Sample Liquid 17>>

Sample liquid 17 was obtained in the same manner as in the production of sample liquid 13 except that the liquid feeding pump at the time of the ultrafiltration was changed to a rotary pump (RPDTR210COMT212243) manufactured by Daido Metal Co., Ltd.

<<Production of Sample Liquid 18>>

Taking 1000 ml of the silver nanowire dispersion liquid 3, then 500 ml of a 0.02 mol/l aqueous solution of polyvinylpyrrolidone (K-30 manufactured by Wako Pure Chemical Industries, Ltd.) was added to the silver nanowire dispersion liquid 3, and the same volume of ethanol was added to the resultant mixture while the resultant mixture was stirred well. Ultrafiltration was carried out using a precision filtration film UNA620 (manufactured by Asahi Kasei Corporation) having a bore size of 0.2 μm and a WM720 type tubing pump manufactured by Iwaki Co., Ltd. as a liquid feeding pump. Washing of adding 800 ml of ethanol solution to the concentrated liquid at the time when the filtrate from the module reached 800 mL was continuously carried out 2 times, thereafter washing of adding 800 mL of a solution of water/1-propanol=1:1 (mass) to the concentrated liquid when the concentrated liquid reached 200 ml was carried out 4 times, and then concentration was carried out until the concentrated liquid reached 100 ml without carrying out washing to obtain sample liquid 18.

<<Production of Transparent Conductive Coating Film>>

PET base materials were coated with sample liquids 1 to 5 and 8 to 18 with a bar so as to have almost the same surface resistivity by adjusting a bar number. With regard to sample liquids 6 and 7, the amount of coating was increased until the haze value exceeded 3.0%, but the surface resistivity could not be adjusted to 150Ω/□ or less.

The ratio of the bent wire, the conductivity, the transmittance, and the haze value for the transparent conductive inks and the coating films were measured. The measurement methods were as follows.

<Ratio of Bent Wire>

With regard to an ink, the ratio of the bent wire in 10000 wires was counted by observing the ink dropped on a mesh by a TEM (JEM-2000FX manufactured by JEOL Ltd.).

With regard to a coating film, the ratio of the bent wire in 10000 wires was counted by observing the coating film by a SEM (S-5200 manufactured by Hitachi, Ltd.).

The ratio of the bent wire was almost the same for the ink and the coating film.

<Measurement of Haze/Light Transmittance>

The CIE luminosity function y under the C illuminant of a conductive layer (or a conductive layer transferred to a transfer object) after forming the conductive layer was measured at a measurement angle of 0° using a Haze-Guard plus manufactured by Gardner.

<Measurement of Surface Resistivity>

The surface resistivity of a conductive layer (or a conductive layer transferred to a transfer object) after forming the conductive layer was measured using a surface resistivity meter (Loresta-GP MCP-T600 manufactured by Mitsubishi Chemical Corporation).

With regard to a resistance value of a patterning sample, since it was difficult to measure a conductive part in the actual fine pattern, an actual pattern and an evaluation pattern (100 mm□) were put in the same sample, and the resistance of the conductive part was measured. The measurement was carried out at 5 points to determine the average value.

<Humidity and Heat Durability>

A patterned conductive member was exposed under an environment of 85° C./85% RH (relative humidity) for 120 hours, and the following ranking was carried out where the resistance value before the exposure was represented by R0 and the resistance value after the exposure was represented by R. In addition, the larger number of the rank shows that the performance is better, and the rank of 3 or more is a level that has no problem in practical use.

[Evaluation Criteria]

5: R/R0 is 1.1 or less and 0.9 or more
4: R/R0 is 1.2 or less and 0.8 or more
3: R/R0 is 1.3 or less and 0.7 or more
2: R/R0 is 1.5 or less and 0.7 or more
1: R/R0 is 1.5 or more, or 0.7 or less

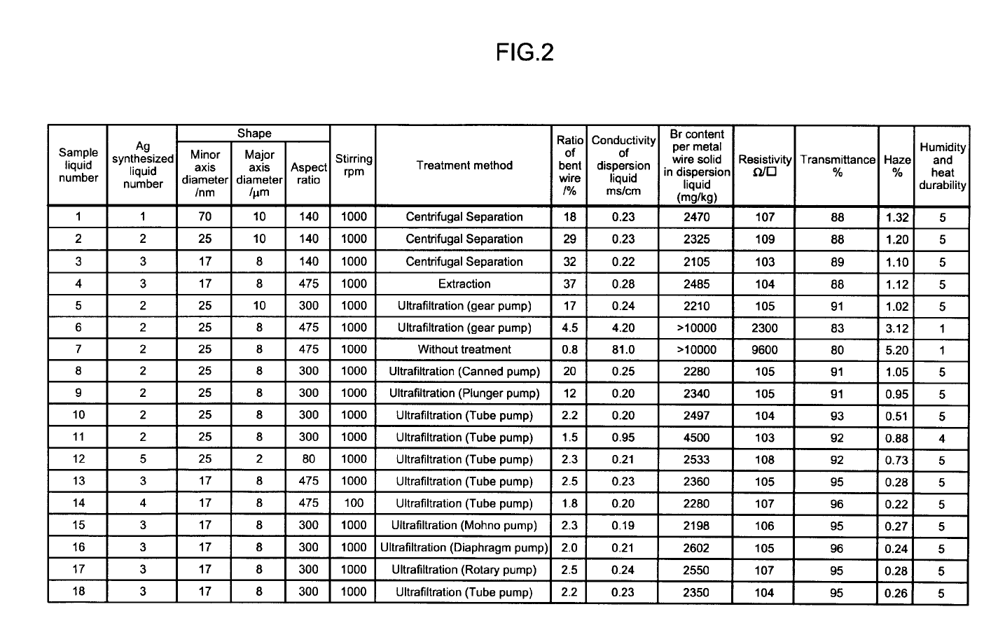

The obtained results are shown in the table of FIG. 2.

As it is understood from the results shown in the table of FIG. 2, it is found that the transmittance can be made high and the haze value can be reduced while a high conductivity is maintained by the ratio of the bent wire in the metal nanowire being 10% or less in the transparent conductive coating film comprising at least a metal nanowire. And it is found that a transparent conductive coating film having a surface resistivity of 150Ω/□ or less, a haze of 1.0% or less, and a transmittance of 92% or more can be obtained by the ratio of the bent wire in the metal nanowire being 10% or less and the conductivity of the conductive ink being 1 mS/cm or less.

### Example 2

### Conductive Layer Transfer Material

<<Production of Cushion Layer>>

A polyethylene terephthalate (PET) film having an average thickness of 30 μm as a base material was coated with a coating liquid for a cushion layer of the following composition and dried to form a cushion layer having an average thickness of 10 μm.

—Composition of Coating Liquid for Cushion Layer—
Methyl methacrylate/2-ethylhexylacrylate/benzyl methacrylate/methacrylic acid copolymer (copolymerization composition ratio (molar ratio)=55/30/10/5, weight average molecular weight=100000, glass transition temperature (Tg)=70° C.) . . . 6.0 parts by mass
Styrene/acrylic acid copolymer (copolymerization composition ratio (molar ratio)=65/35, weight average molecular weight=10000, glass transition temperature (Tg)=100° C. . . . 14.0 parts by mass
BPE-500 (manufactured by Shin-Nakamura Chemical Co., Ltd.) . . . 9.0 parts by mass
Megafac F-780-F (Dainippon Ink & Chemicals, Inc.) . . . 0.5 parts by mass
Methanol . . . 10.0 parts by mass
Propylene glycol monomethyl ether acetate . . . 5.0 parts by mass
Methylethylketone . . . 55.5 parts by mass

<<Production of Conductive Layer>>

—Synthesis of Binder (A-1)—

As monomer components constituting a copolymer, 7.79 g of methacrylic acid and 37.21 g of benzyl methacrylate were used, 0.5 g of azobisisobutyronitrile was used as a radical polymerization initiator, and these monomers and a polymerization initiator were subjected to polymerization reaction in 55.00 g of propylene glycol monomethyl ether acetate (PGMEA) to obtain a PGMEA solution (solid concentration: 40 mass %) of a binder (A-1) having the following structure. In addition, the polymerization temperature was adjusted to a temperature of 60° C. to 100° C.

The molecular weight was measured using gel permeation chromatography (GPC), and as a result thereof, the weight average molecular weight (Mw) was 30,000 in terms of polystyrene, and the molecular weight distribution (Mw/Mn) was 2.21.

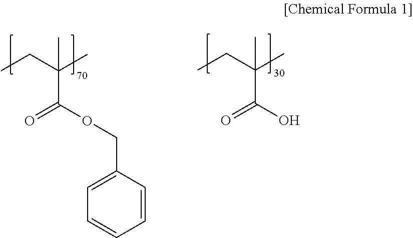

—Preparation of Composition for Negative Type Conductive Layer—

A composition for a negative type conductive layer was prepared by adding 0.241 parts by mass of the binder (A-1), 0.252 parts by mass of KAYARAD DPHA (manufactured by Nippon Kayaku Co., Ltd.), 0.0252 parts by mass of IRGACURE379 (manufactured by Ciba Specialty Chemicals Inc.), 0.0237 parts by mass of EHPE-3150 (manufactured by Dicel Chemical Industries, Ltd.) as a crosslinking agent, 0.0003 parts by mass of Megafac F781F (manufactured by DIC Corporation), 0.9611 parts by mass of propylene glycol monomethyl ether acetate (PGMEA), 44.3 parts by mass of 1-methoxy-2-propanol (MFG), and propylene glycol monomethyl ether acetate dispersion liquid of the silver nanowire (sample liquids 1 to 17) and stirring the resultant mixture.

—Formation of Conductive Layer—

The films on which the cushion layer was formed were coated with the obtained compositions for a negative type conductive layer so that the surface resistivity became almost the same, and dried to form conductive layers each having an average thickness of 0.1 μm. Conductive layer transfer materials were produced as described above.

Here, the mass ratio (A/B) of the content A of the components other than the metal nanowire to the content B of the metal nanowire in the conductive layer was 0.6.

<Patterning Treatment>

The conductive layer and the cushion layer of each conductive layer transfer material were transferred to a transfer object (a glass substrate having a thickness of 0.7 mm), and thereafter a stripe-shaped pattern having a line and space (hereinafter referred to as L/S)=100 μm/100 μm was produced by the following method. In addition, the cushion layer was removed by shower development.

[Patterning Condition]

Exposure was carried out by irradiating an i-line (365 nm) of a high pressure mercury lamp of 100 mJ/cm² (illuminance 20 mW/cm²) from above the mask. The shower development of the substrate after the exposure was carried out for 30 seconds with a developing solution in which 5 g of sodium bicarbonate and 2.5 g of sodium carbonate were dissolved in 5,000 g of pure water. The shower pressure was 0.04 MPa, and the time until a stripe pattern emerged was 15 seconds. Next, the substrate was rinsed with a pure water shower.

Also in the case where the sample liquids of Example 1 were put in the conductive layer, the effect exhibiting a high transmittance and a low haze was similarly obtained by the nanowire having a small ratio of the bent wire of the present invention.

### Example 3

### Sol-Gel Matrix Conductive Layer Material

<<Production of PET Substrate>>

Corona discharge treatment of 1 J/m² was applied to a surface of a polyethylene terephthalate (PET) film having an average thickness of 125 μm as a base material, and thereafter the resulting surface was coated with a solution 1 for adhesion of the following composition and dried at 120° C. for 2 minutes to form an adhesion layer 1 having a thickness of 0.11 μm. Next, corona discharge treatment of 1 J/m² was applied to the PET substrate to which the first adhesion layer was applied. Thereafter, the PET substrate was coated with a solution 2 for adhesion of the following composition and dried at 170° C. for 1 minute to form an adhesion layer 2 having a thickness of 0.5 μm. Next, the PET substrate to which the first and the second adhesion layers were applied was coated with a solution 3 for adhesion of the following composition and dried at 120° C. for 1 minute to form an adhesion layer 3 having an average thickness of 1 nm.

Solutions 1, 2, and 3 for adhesion were prepared by the following combination.

—Solution 1 for Adhesion—

| | |
|---|---|
| TAKELAC WS-4000 | 5.0 parts |
| (Polyurethane for coating, solid concentration 30%, | |
| manufactured by Mitsui Chemicals, Inc.0)0 | |
| Surfactant | 0.3 parts |
| (NAROACTY HN-100, manufactured by Sanyo | |
| Chemical Industries, Ltd.) | |
| Surfactant | 0.3 parts |
| (SANDET BL, solid concentration 43%, manufactured by | |
| Sanyo Chemical Industries, Ltd.) | |
| Water | 94.4 parts |

—Solution 2 for Adhesion—

| | |
|---|---|
| Tetraethoxysilane | 5.0 parts |
| (KBE-04, manufactured by Shin-Etsu Chemical Co., Ltd.) | |
| 3-glycidoxypropyltrimethoxy silane | 3.2 parts |
| (KBM-403, manufactured by Shin-Etsu Chemical Co., Ltd.) | |
| 2-(3,4-epoxycyclohexyl)ethyltrimethoxy silane | 1.8 parts |
| (KBM-303, manufactured by Shin-Etsu Chemical Co., Ltd.) | |
| Acetic acid aqueous solution (acetic acid | 10.0 parts |
| concentration = 0.05%, pH = 5.2) | |
| Curing agent | 0.8 parts |
| (Boric acid, manufactured by Wako Pure | |
| Chemical Industries, Ltd.) | |
| Colloidal silica | 60.0 parts |
| (SNOWTEX O, average particle diameter 10 nm to 20 nm, | |
| solid concentration 20%, pH = 2.6, manufactured | |
| by Nissan Chemical Industries, Ltd.) | |
| Surfactant | 0.2 parts |
| (NAROACTY HN-100, manufactured by Sanyo | |
| Chemical Industries, Ltd.) | |
| Surfactant | 0.2 parts |
| (SANDET BL, solid concentration 43%, manufactured | |
| by Sanyo Chemical Industries, Ltd.) | |

The solution 2 for adhesion was prepared in the following manner.

While the acetic acid aqueous solution was vigorously stirred, 3-glycidoxypropyltrimethoxy silane was dropped to the acetic acid aqueous solution in 3 minutes. Next, 2-(3,4-epoxycyclohexyl)ethyltrimethoxy silane was added to the acetic acid aqueous solution in 3 minutes while the acetic acid aqueous solution was intensely stirred. Next, tetramethoxysilane was added to the acetic acid aqueous solution in 5 minutes while the acetic acid aqueous solution was intensely stirred, and thereafter stirring was continued for 2 hours. Next, colloidal silica, the curing agent, and the surfactants were sequentially added to make the solution 2 for adhesion.

—Solution 3 for Adhesion—

| | |
|---|---|
| N-(2-aminoethyl)-3-aminopropyltrimethoxy silane | 0.02 parts |
| Distilled water | 99.8 parts |

The solution 3 for adhesion was prepared by the following method. Water was added to N-(2-aminoethyl)-3-aminopropyltrimethoxy silane, and the resultant mixture was stirred for 1 hour to make the solution 3 for adhesion.

<<Production of Conductive Layer>>

Corona discharge treatment of 1 J/m² was applied to the surface of the base material on which the layers were formed to the adhesion layer 3, thereafter the substrate was coated with a conductive layer coating liquid of the following composition and dried at 120° C. for 1 minute, and thereby a conductive layer having a thickness of 0.04 μm was formed to obtain a conductive member of Example 3.

—Preparation of Conductive Layer Coating Liquid—

A solution of an alkoxide compound of the following composition was stirred at 60° C. for 1 hour to confirm that the solution became uniform. Mixed were 3.44 parts of the obtained sol-gel solution and 16.56 parts of “sample liquid 18” obtained in Example 1, and the resultant mixture was further diluted with distilled water to obtain a coating liquid for forming a conductive layer.

—Solution of Alkoxide Compound—

| | |
|---|---|
| Tetraethoxysilane (Compound (II)) | 5.0 parts |
| (KBE-04, manufactured by Shin-Etsu Chemical Co., Ltd.) | |
| 1% Acetic acid aqueous solution | 10.0 parts |
| Distilled water | 4.0 parts |

<Patterning>

Patterning treatment was applied to the conductive member obtained above by the following method. A WHT-3 type and a squeegee No. 4 Yellow both manufactured by Mino Group Co., Ltd. were used for screen printing. A dissolved solution of a silver nanowire for forming a pattern was formed by mixing a CP-48S-A solution, a CP-48S-B solution (both manufactured by FujiFilm Corporation), and a pure water so that the mixing ratio became 1:1:1 and increasing the viscosity by hydroxymethylcellulose to make an ink for screen printing. A pattern mesh having a stripe pattern (line/space=50 μm/50 μm) was used. The above-described patterning treatment was carried out to form a conductive layer including a conductive region and a non-conductive region.

The effect exhibiting a high transmittance and a low haze was similarly obtained also in the conductive layer of Example 3 by the nanowire having a small ratio of the bent wire of the present invention.

What is claimed is:

1. A transparent conductive coating film comprising at least a metal nanowire, wherein the transparent conductive coating film has a ratio of a bent wire in the metal nanowire of 10% or less, a surface resistivity of 150Ω/□ or less, and a haze value of 1.0% or less.

2. The transparent conductive coating film according to claim 1, wherein the transparent conductive coating film has a ratio of the bent wire of 2.5% or less.

3. The transparent conductive coating film according to claim 1, wherein the transparent conductive coating film has a transmittance of 92% or more.

4. The transparent conductive coating film according to claim 1, wherein the transparent conductive coating film has a haze value of 0.6% or less.

5. The transparent conductive coating film according to claim 1, wherein the metal nanowire has a number average aspect ratio of 20 or more.

6. The transparent conductive coating film according to claim 1, wherein the metal nanowire has a number average major axis diameter of 1 μm or more.

7. The transparent conductive coating film according to claim 1, wherein the metal nanowire has a number average minor axis diameter of 50 nm or less.

8. The transparent conductive coating film according to claim 1, wherein the metal nanowire has a number average minor axis diameter of 30 nm or less.

9. The transparent conductive coating film according to claim 1, wherein the metal nanowire has a number average minor axis diameter of 20 nm or less.

10. The transparent conductive coating film according to claim 1, wherein a purification step in preparing a metal nanowire dispersion liquid is an ultrafiltration system, a liquid feeding pump used in ultrafiltration is any one of a tube pump, a mohno pump, a diaphragm pump, and a rotary pump, and the transparent conductive coating film is produced by forming a coating film by coating with the metal nanowire dispersion liquid.

11. A transparent conductive ink comprising at least a metal nanowire, wherein the transparent conductive ink has a ratio of a bent wire in the metal nanowire of 10% or less and a conductivity of 1 mS/cm or less.

12. The transparent conductive ink according to claim 11, wherein the transparent conductive ink has a Br content per metal nanowire solid content in the ink of 5000 ppm or less.

13. The transparent conductive ink according to claim 11, wherein a purification step in preparing a metal nanowire dispersion liquid is an ultrafiltration system, a liquid feeding pump used in ultrafiltration is any one of a tube pump, a mohno pump, a diaphragm pump, and a rotary pump, and the transparent conductive ink is produced with the metal nanowire dispersion liquid.

14. A touch panel using the transparent conductive coating film according to claim 1.

15. A touch panel produced by using the transparent conductive ink according to claim 11.
